(19) United States
(12) Patent Application Publication
(10) Pub. No.: US 2013/0225280 A1
(43) Pub. Date: Aug. 29, 2013

(54) PHYSICAL AND VIRTUAL GAME PIECES AND ASSOCIATED DEVICES, SYSTEMS, AND METHODS

(71) Applicant: Jonathan E. Levine, New York, NY (US)

(72) Inventor: Jonathan E. Levine, New York, NY (US)

(21) Appl. No.: 13/763,672

(22) Filed: Feb. 9, 2013

Related U.S. Application Data
(63) Continuation-in-part of application No. 13/204,581, filed on Aug. 5, 2011.
Application No. 13/204,581 is a continuation-in-part of application No. 12/851,153, filed on Aug. 5, 2010.
Application No. 12/851,153 is a continuation of application No. PCT/US11/46859, filed on Aug. 5, 2011.

(51) Int. Cl. A63F 13/00

(52) U.S. Cl. CPC A63F 13/00
USPC 463/29

(57) ABSTRACT

Physical and virtual game pieces and associated devices, systems, and methods are disclosed herein. A method in accordance with a particular embodiment includes creating first physical or virtual game pieces of a first type, creating second physical or virtual game pieces of a second type different than the first type, and distributing the first and second game pieces based on different distribution criteria. The first and second game pieces are associated with different advertisers and are configured to be redeemed in a predetermined set including one or more of the first game pieces and one or more of the second game pieces.

### CROSS-REFERENCE TO RELATED APPLICATIONS

This is a continuation-in-part of U.S. patent application Ser. No. 13/204,581, filed Aug. 5, 2011, titled “ADJUSTABLE ELECTRONIC GAME PIECE,” which is a continuation-in-part of U.S. patent application Ser. No. 12/851,153, filed Aug. 5, 2010, titled “ELECTRONIC GAME PIECE,” and a continuation of PCT International Application No. US2011/046859, filed Aug. 5, 2011, titled “ADJUSTABLE ELECTRONIC GAME PIECE.” The foregoing applications are incorporated herein by reference in their entireties.

### TECHNICAL FIELD

The present technology is related to, among other things, physical and virtual game pieces, methods for creating and distributing the game pieces, methods for redeeming the game pieces, methods for optimizing the game pieces, and associated devices, systems, and methods.

### BACKGROUND

Sweepstakes, games, and puzzles often involve the use of individual, interrelated game pieces. For example, in some sweepstakes, individual game pieces are distributed and used in conjunction with a game board. Participants in the sweepstakes collect the individual game pieces with the goal of forming a set, such as a set corresponding to indicia on the game board. In puzzles used primarily for amusement, individual pieces often are arranged relative to one another in order to solve the puzzle. In a simple example, solving a traditional jigsaw puzzle involves arranging differently shaped puzzle pieces until they fit together to form an image. There is a demand for new types of sweepstakes, games, and puzzles to engage increasingly sophisticated consumers. Innovative game pieces can be useful in these and other contexts.

### BRIEF DESCRIPTION OF THE DRAWINGS

FIG. 1 is a perspective view of a physical game piece configured in accordance with an embodiment of the present technology, as viewed from the top and one side.

FIG. 2 is a top plan view of the physical game piece shown in FIG. 1.

FIG. 3 is a bottom plan view of the physical game piece shown in FIG. 1.

FIG. 4 is a front profile view of the physical game piece shown in FIG. 1.

FIG. 5 is a back profile view of the physical game piece shown in FIG. 1.

FIG. 6 is a first side profile view of the physical game piece shown in FIG. 1.

FIG. 7 is a second side profile view of the physical game piece shown in FIG.

FIG. 8A is a top plan view of the inside of the top portion of the physical game piece shown in FIG. 1.

FIG. 8B is a top plan view of the inside of the bottom portion of the physical game piece shown in FIG. 1.

FIG. 9A is a perspective view of a light, a proximity sensor, batteries, and associated electrical connections of the physical game piece shown in FIG. 1 with the proximity sensor not activated and the light off, as viewed from the top and one side.

FIG. 9B is a perspective view of a light, a proximity sensor, batteries, and associated electrical connections of the physical game piece shown in FIG. 1 with the proximity sensor activated and the light on, as viewed from the top and one side.

FIG. 10A is a top plan view of the inside of the top portion of a physical game piece configured in accordance with another embodiment of the present technology.

FIG. 10B is a top plan view of the inside of the bottom portion of the physical game piece shown in FIG. 10A.

FIG. 11A is a top plan view of the inside of the top portion of a physical game piece configured in accordance with another embodiment of the present technology.

FIG. 11B is a top plan view of the inside of the bottom portion of the physical game piece shown in FIG. 11A.

FIG. 12 is a front profile view of the physical game piece shown in FIG. 1-9B, the physical game piece shown in FIGS. 10A-10B, and the physical game piece shown in FIGS. 11A-11B stacked such that the lights of all three physical game pieces are aligned and illuminated.

FIG. 13 is a front profile view of the physical game piece shown in FIG. 1-9B, the physical game piece shown in FIGS. 10A-10B, and the physical game piece shown in FIGS. 11A-11B positioned in a physical game piece holder configured in accordance with an embodiment of the present technology and stacked such that the lights of all three physical game pieces are aligned, illuminated, and visible through a single vertical opening in the physical game piece holder.

FIG. 14 is a front profile view of the physical game piece shown in FIG. 1-9B, the physical game piece shown in FIGS. 10A-10B, and the physical game piece shown in FIGS. 11A-11B positioned in a physical game piece holder configured in accordance with another embodiment of the present technology and stacked such that the lights of the three physical game pieces are not aligned, not illuminated, and positioned behind separate openings in the physical game piece holder.

FIG. 15 is a block diagram illustrating an environment in which the present technology may operate in some embodiments.

FIG. 16 is a flow diagram illustrating a routine invoked by the present technology in some embodiments to create and distribute virtual game pieces.

FIG. 17 is a flow diagram illustrating a routine invoked by the present technology in some embodiments when a consumer redeems virtual game pieces.

FIG. 18 is a flow diagram illustrating a routine invoked by the present technology in some embodiments to distribute virtual game pieces.

FIG. 19 is a block diagram illustrating components employed by the present technology in some embodiments.

### DETAILED DESCRIPTION

Described herein are embodiments of physical and virtual game pieces and associated devices, systems, and methods. In some embodiments, the game pieces are well suited for use in promotional games, such as sweepstakes, in which the game pieces are given away for promotional purposes. In some cases, the game pieces also can be purchased or traded. Multiple game pieces can be collected and grouped to create sets, which can be intrinsically desirable or exchangeable for a prize. For example, the game pieces can be given away to the first customers at a new retail location, to customers who purchase certain items, to trade show attendees, or to individuals in any other scenario in which the prospect of receiving a game piece serves a promotional purpose. The game pieces can also independently serve a promotional purpose (e.g., by communicating a promotional message). Furthermore, in some embodiments, the game pieces facilitate the collection of consumer information.

Separate game pieces can be unique (e.g., characterized by one or more unique physical or virtual characteristics) and/or can belong to a type (e.g., a class, a group, etc.) that includes multiple game pieces sharing one or more unifying physical or virtual characteristics. In some embodiments, a unifying characteristic among game pieces of a type is association with the same advertiser or group of advertisers. The advertisers, for example, can be manufacturers, service providers, or indeed any person or other entity that is interested in advertising offerings or otherwise creating game pieces. With respect to virtual game pieces, a unifying characteristic among game pieces of a type, for example, can be assignment of identifiers associated with the game pieces to a designated type in a database. As used herein, the term “game piece” refers to a game piece or a type of game piece unless the context clearly indicates otherwise. Similarly, the term “game pieces” refers to multiple game pieces or multiple types of game pieces unless the context clearly indicates otherwise.

Game pieces can derive value from their relationships with one another. For example, the game pieces can be configured for redemption in sets individually including two or more unique game pieces or members of two or more different types of game pieces. In this way, the game pieces can serve as the basis for a variety of promotional games, including cross-promotional games. For example, game pieces belonging to a first type of game pieces associated with a first advertiser or group of advertisers and game pieces belonging to a second type of game pieces associated with a second advertiser or group of advertisers can be redeemable together in one or more sets. A desire to complete the sets can motivate customers of the first advertiser or group of advertisers to engage the second advertiser or group of advertisers (e.g., to initiate a purchase or other transaction with the second advertiser or group of advertisers) and can motivate customers of the second advertiser or group of advertisers to engage the first advertiser or group of advertisers (e.g., to initiate a purchase or other transaction with the first advertiser or group of advertisers). The game pieces can also be redeemable in other types of sets, such as sets in which the constituent game pieces are all associated with the same advertiser or group of advertisers, sets in which the constituent game pieces are associated with more than two advertisers or groups of advertisers, and sets in which the constituent game pieces are not associated with any advertisers.

Different types of physical game pieces can differ from one another, for example, with respect to one or more physical characteristics that create an interrelationship between the game pieces. For example, in some embodiments, different types of physical game pieces differ in the quantity and/or arrangement of internal proximity sensors and proximity sensor targets. The proximity sensor target of one game piece can activate the proximity sensor of a separate game piece when the two are aligned. Activating a proximity sensor can cause a light to illuminate on the game piece including the proximity sensor. Aligning multiple proximity sensors and proximity sensor targets can cause lights on multiple game pieces to illuminate. In this way, multiple game pieces can be arranged and rearranged as a puzzle to determine an arrangement in which all of the lights are illuminated. A winning arrangement of game pieces can be a set in which a certain number of game pieces (e.g., three, four, five, or a greater number) are stacked with the lights aligned and simultaneously illuminated. This can occur, for example, when each of the game pieces in the stack includes a proximity sensor activated by a proximity sensor target of an adjacent game piece in the stack. In some embodiments, the lights of the game pieces illuminate only when the lights are in a particular arrangement. As an example, the lights may illuminate only when the lights of two or more stacked game pieces of a set are vertically aligned.

In some embodiments, the game pieces include no indication of their unique identity and/or type. For example, identifying characteristics of physical game pieces can be sealed within a shell and groupings of identifiers of virtual game pieces (e.g., corresponding to types of the virtual game pieces) can be stored in a secured database. In some cases, the primary way to identify a game piece is to test how the game piece interacts with other game pieces. Furthermore, even when the identity and/or type of a game piece is known, it can be useful to test how the game piece can be grouped or otherwise arranged with other game pieces to create various sets. With physical game pieces, this testing can occur manually. With virtual game pieces, this testing can occur manually (e.g., via a user interface that creates virtual two-dimensional or three-dimensional representations of the game pieces that can be manipulated in a virtual environment) or automatically (e.g., via automatically executed software algorithms). Some game pieces can be less common than others. Controlling the availability of certain critical game pieces can allow for control over the probability of obtaining a set of game pieces capable of forming a set. This control can be useful, for example, when the game pieces are used in a sweepstakes and the set is exchangeable for a prize. Game pieces in accordance with embodiments of the present technology also can be sold in sets as puzzles for amusement, in which case at least one of each game piece configuration required to complete the puzzle can be included or readily obtainable.

When used in a sweepstakes, game pieces configured in accordance with embodiments of the present technology can have one or more features to reduce or prevent tampering. For example, physical game pieces can be sealed such that accessing internal portions of the game pieces is only possible by breaking the game pieces. The game pieces can be encased, for example, in hard plastic, tamper evident shells. In some cases, tampering also can be reduced or prevented with the use of identifiers, such as a serial numbers with respect to physical and virtual game pieces and/or radiofrequency identification tags with respect to physical game pieces. The game piece type (e.g., the internal configuration with respect to physical game pieces) corresponding to each identifier can be recorded prior to distribution of the game pieces for reference when a winning set of game pieces is redeemed. With regard to virtual game pieces, the identifiers can be organized into categories within a database with each category representing a different game piece type. Furthermore, the game pieces can be tracked. For example, ownership information for physical and virtual game pieces can be stored in a secured database and updated at suitable times (e.g., upon distribution of a game piece, upon clearance of a game piece trade or other transaction, upon redemption of a game piece, upon destruction of a game piece, at regular intervals, at irregular intervals, or at other suitable times).

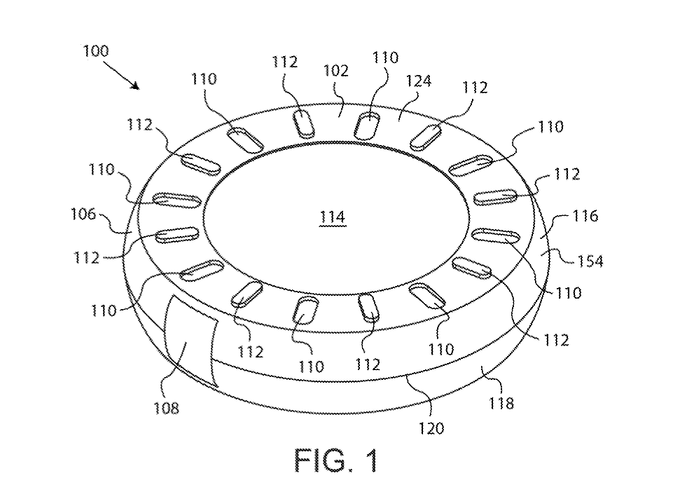

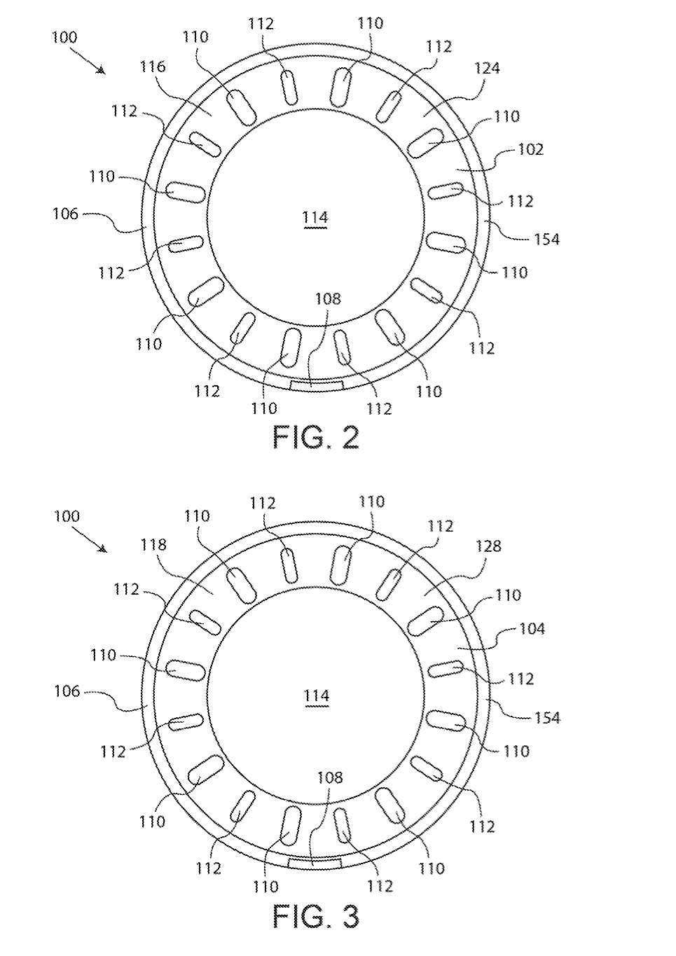

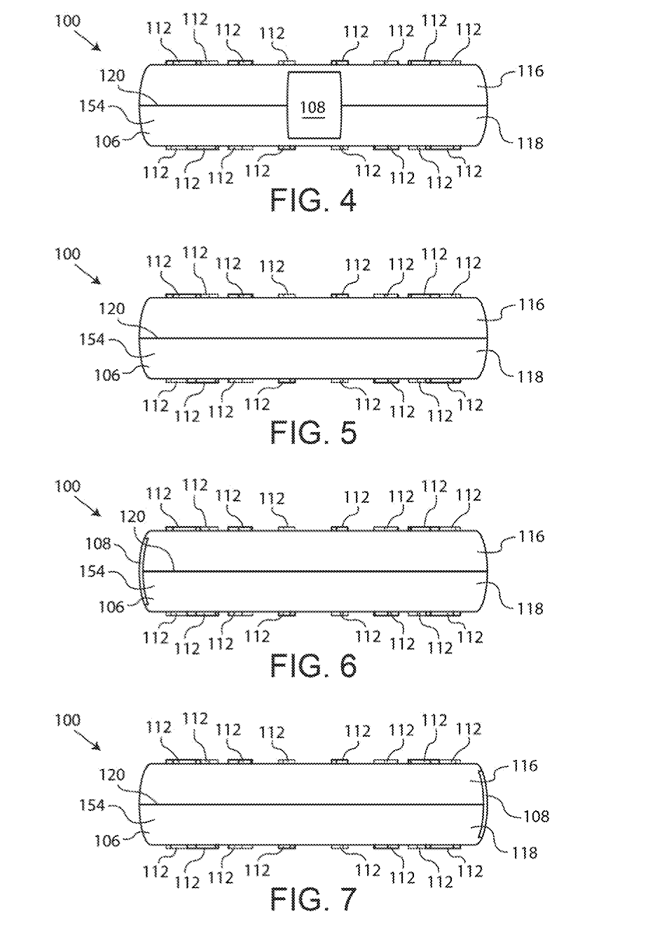

FIGS. 1-7 illustrate the external appearance of a physical game piece configured in accordance with an embodiment of the present technology. As shown in FIG. 1, the game piece 100 can be shaped substantially as a short cylinder. In other embodiments, the game piece can have other suitable shapes. For example, the game piece 100 can be shaped as a triangular prism, a cuboid, a pentagonal prism, a hexagonal prism, or an octagonal prism. In the illustrated game piece 100, the top major surface 102 (as shown, for example, in FIGS. 1 and 2) and the bottom major surface 104 (as shown, for example, in FIG. 3) can be parallel to one another, and each can be generally flat and round. A side surface 106 can join the perimeter of the top major surface 102 at one end and the perimeter of the bottom major surface 104 at the opposite end. A window 108 can be positioned in a portion of the side surface 106. The window 108 can be made of a suitable translucent material (e.g., clear plastic or glass, among others). Opaque portions of the game piece 100 can be made of plastic, metal, a resin composite, or other materials with suitable characteristics (e.g., suitable strength characteristics).

As shown in FIGS. 1-3, recesses 110 and protrusions 112 can be circumferentially distributed around center portions 114 of the top major surface 102 and the bottom major surface 104. For each recess 110 on the top major surface 102, there can be a corresponding protrusion 112 on the bottom major surface 104 at the same circumferential position around the center portion 114. Similarly, for each protrusion 112 on the top major surface 102, there can be a corresponding recess 110 on the bottom major surface 104 at the same circumferential position around the center portion 114. The recesses 110 and protrusions 112 can allow for an interlocking relationship between the top and bottom major surfaces of separate game pieces having the same external configuration. For example two game pieces identical to the game piece 100 can be stacked such that a bottom major surface of one of the game pieces interlocks with a top major surface of the other game piece. When interlocking, each protrusion and recess on the bottom major surface of one of the game pieces can fit within or around a recess or protrusion, respectively, on the top major surface of the other game piece. Based on the pattern of recesses and protrusions of the game piece 100, two identical game pieces can be rotated relative to one another and interlocked in one of eight rotational configurations. The number of possible interlocking rotational configurations can be increased or decreased by increasing or decreasing, respectively, the number of alternating recesses and protrusions.

The center portions 114 of the top and bottom major surfaces 102, 104 of the game piece 100 each can be flat and slightly recessed. In some embodiments, text and/or images can be affixed (e.g., printed or attached with a sticker) to one or both of the center portions of the top and bottom major surfaces. The text and/or images can be promotional, decorative, or have another suitable purpose. Text and/or images also can be affixed to other portions of the game piece, such as around the side surface. In one example, a corporate logo is affixed to the center portions of the top and bottom major surfaces and a text trademark is affixed around the side surface of the game piece.

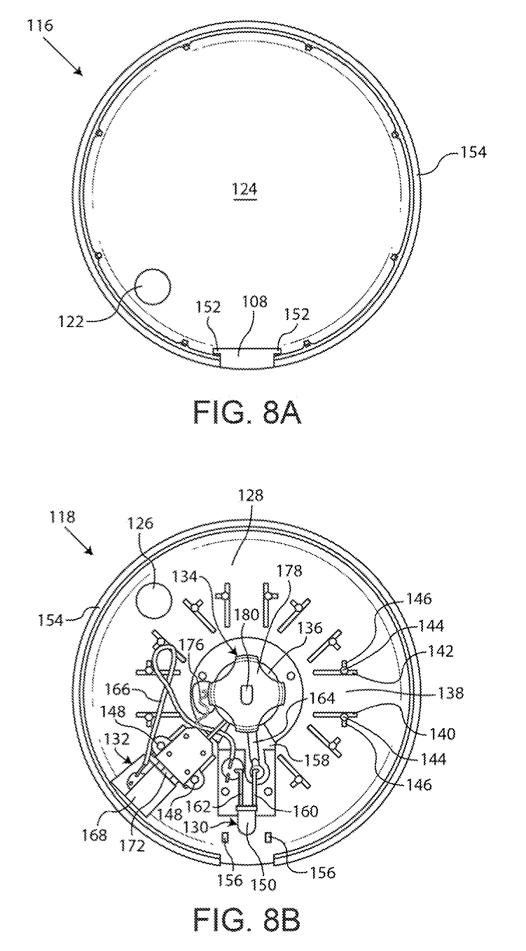

FIGS. 8A and 8B illustrate the configuration of internal components within the game piece 100 shown in FIGS. 1-7. FIG. 8A shows the inside of a top portion 116 of the game piece 100. FIG. 8B shows the inside of a bottom portion 118 of the game piece 100. As shown in FIGS. 1-7, a seam 120 can separate the top portion 116 and the bottom portion 118 of the game piece 100. In other embodiments, the top portion and the bottom portion can be sealed together so that no visible seam remains (e.g., the top portion and the bottom portion can be fused with heat). As shown in FIG. 8A, a top magnet 122 can be attached to the underside of a top wall 124. The side of the top wall 124 opposite to the underside can be the top major surface 102 of the game piece 100. As shown in FIG. 8B, a bottom magnet 126 can be attached to the top side of a bottom wall 128. The side of the bottom wall 128 opposite to the top side can be the bottom major surface 104 of the game piece 100. In addition to the bottom magnet 126, the top side of the bottom wall 128 can include a light 130, a proximity sensor 132, and a battery compartment 134 housing a battery stack 136. The battery stack 136 can include two button cell batteries arranged in series. In other embodiments, game pieces can include different power supply configurations. Game pieces powered by batteries, for example, can include any suitable number, type, and arrangement of batteries, such as one button cell battery, one AAA battery, or two AAA batteries arranged in parallel or in series.

As shown in FIG. 8B, the top side of the bottom wall can include seven proximity sensor bays 138 circumferentially distributed around the battery compartment 134. A first support wall 140 and a second support wall 142 can create the sides of each of the proximity sensor bays 138. Pegs 144 can extend vertically from the first and second support walls 140, 142. Struts 146 can provide additional rigidity to the first and second support walls 140, 142 and the pegs 144. For clarity in FIG. 8B, only the rightmost of the seven proximity sensor bays 138 and its corresponding first and second support walls 140, 142, pegs 144, and struts 146 are labeled with reference numbers. As show in FIG. 8B, the proximity sensor 132 can be positioned in the proximity sensor bay 138 closest to the light 130 in a clockwise circumferential direction when viewed from above. The pegs 144 of the first and second support walls 140, 142 of this proximity sensor bay 138 can fit within peg holes 148 on either side of the proximity sensor 132 to hold the proximity sensor in place. In other embodiments, game pieces can include different structures to hold the proximity sensors in certain circumferential positions or no such structures. Game pieces including structures to hold the proximity sensors in certain circumferential positions can include different numbers of such structures. For example, in some embodiments a game piece can include three, four, five, six, eight, nine, ten, eleven, twelve, or a different number of proximity sensor bays.

In the illustrated game piece 100, the light 130 is a light emitting diode (LED) 150. In other embodiments, the game piece can include a different type of light, such as an incandescent, fluorescent, halogen, xenon, neon, or another commercially available type of light. LEDs can be particularly well suited for use in at least some embodiments due, for example, to their compact size, low power demand, low heat output, long life, and high durability. In a particular embodiment, the LED 150 of the game piece 100 is blue. Instead of a blue LED, in other embodiments, a game piece can include a LED of another color, such as white, red, orange, yellow, or green. The LED 150 can be positioned behind the window 108. The window 108 can be frosted such that light from the LED 150 is visible through the window when the LED is illuminated, but the structure of the LED is not visible through the window when the LED is not illuminated. As shown in FIG. 8A, the window 108 can include support flanges 152 on each side. The support flanges 152 can hold the window 108 in place between the surrounding side wall 154 and two window support tabs 156 attached to the top side of the bottom wall 128. In some embodiments, game pieces can have multicolored lights, such as lights of varying colors. As an example, the lights of a game piece may change colors depending on which other game pieces or other objects are proximate to the game piece.

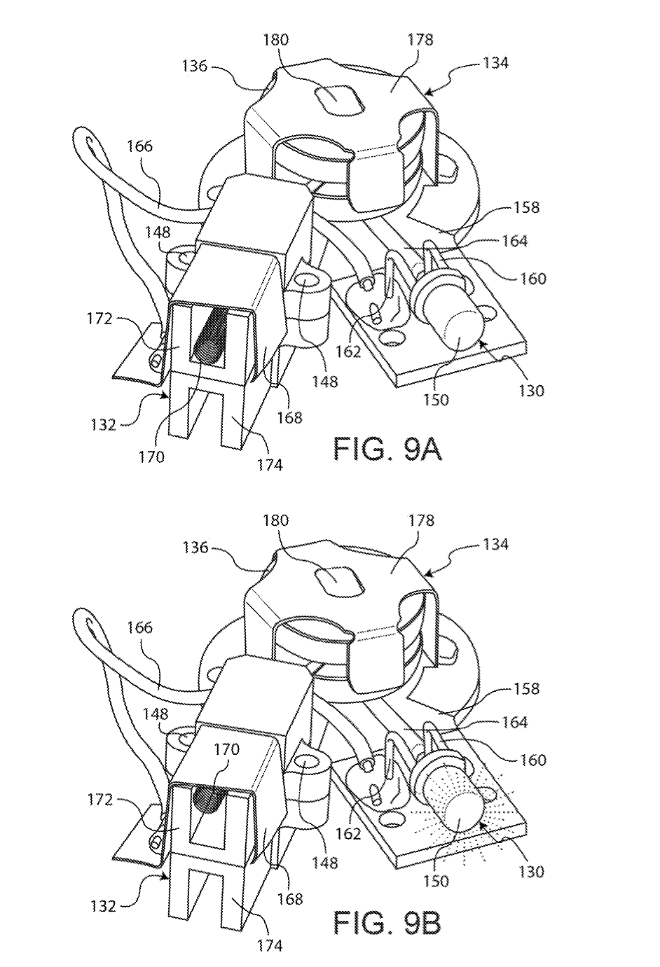

The light 130, proximity sensor 132, battery stack 136, and associated electrical connections are shown in greater detail in FIGS. 9A-9B. The light 130 and the battery compartment 134 can be supported on a plate 158 made, for example, of insulating plastic. The LED 150 can include a first terminal 160 and a second terminal 162. The first terminal 160 of the LED 150 can be connected to a first terminal (not shown) of the battery stack 136 via a contact strip 164 electrically isolated on the plate 158. The second terminal 162 of the LED 150 can be soldered to one end of a first wire 166. The other end of the first wire 166 can be connected to a contact plate 168 of the proximity sensor 132. The proximity sensor 132 can also include a spring 170, an upper spring compartment 172, and a lower spring compartment 174. The spring 170 can be positioned in the upper spring compartment 172. As shown in FIG. 8B, a second wire 176 can extend from the back of the proximity sensor 132. One end of the second wire 176 can be connected to a back end of the spring 170. The other end of the second wire 176 can be connected to a main housing 178 of the battery compartment 134. The main housing 178 of the battery compartment 134 can be electrically connected to a second terminal (not shown) of the battery stack 136, such as with a contact tab 180.

FIGS. 9A and 9B illustrate operation of the proximity sensor 132. In FIG. 9A, the spring 170 is shown in a resting position separated from the contact plate 168. When a magnet of a separate game piece is positioned in close proximity and above the proximity sensor 132, the magnetic field of the magnet can move the spring 170 into the position shown in FIG. 9B. In this way, the magnet can serve as a proximity sensor target. In FIG. 9B, the front end of the spring 170 can be stretched upward into contact with the contact plate 168. This can complete the circuit between the light 130 and the battery stack 136, thereby causing the light to illuminate. When the magnet of the separate game piece is moved away from the proximity sensor 132, the spring 170 may be no longer affected by the magnetic field of the magnet and, therefore, may resiliently return to the resting position separated from the contact plate 168. This can cause the circuit to be broken and the light 130 to turn off. The U-shape of the upper spring compartment 172 can restrict movement of the spring 170 so that the spring only moves into contact with the contact plate 168 if a magnet is in substantial alignment with the proximity sensor 132. This can increase the selectivity of the proximity sensor 132 according to the specific position of the separate game piece.

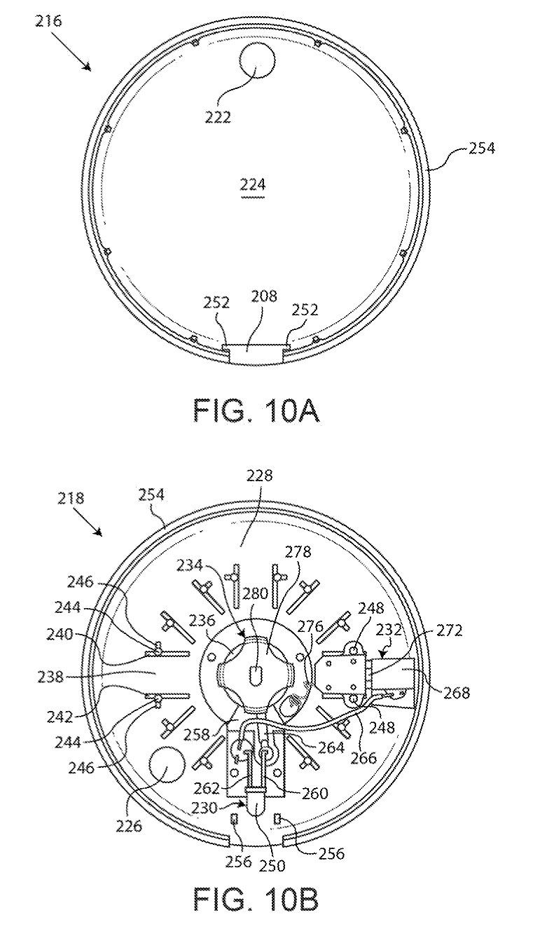

FIGS. 10A-10B illustrate the internal components of a second embodiment of the game piece. The first digit of each reference number shown in FIGS. 10A-10B is “2.” The final two digits of the reference numbers shown in FIGS. 10A-10B are identical to the final two digits of the reference numbers shown in FIGS. 1-9B for similar or identical elements. For clarity in FIG. 10B, only the leftmost of the seven proximity sensor bays 238 and its corresponding first and second support walls 240, 242, pegs 244, and struts 246 are labeled with reference numbers. The external portions of the game piece 200 shown in FIGS. 10A-10B can be the same as the external portions of the game piece 100 shown in FIGS. 1-9B. As shown in FIG. 10A-10B, the game piece 200 can include a top magnet 222, a bottom magnet 226, and a proximity sensor 232 similar to the top magnet 122, the bottom magnet 126, and the proximity sensor 132 of the game piece 100, but at different circumferential positions.

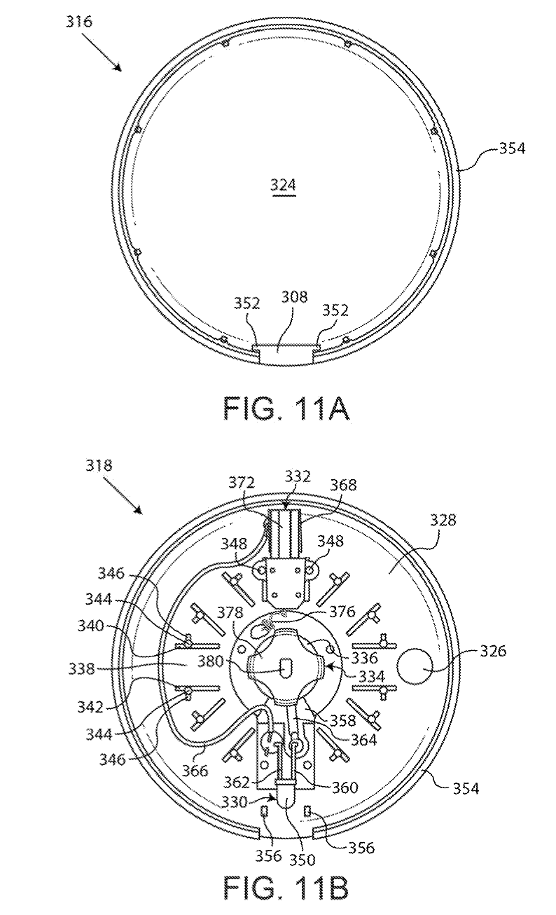

FIGS. 11A-11B illustrate the internal components of a third embodiment of the game piece. The first digit of each reference number shown in FIGS. 11A-11B is “3.” The final two digits of the reference numbers shown in FIGS. 11A-11B are identical to the final two digits of the reference numbers shown in FIGS. 1-9B for similar or identical elements. For clarity in FIG. 11B, only the leftmost of the seven proximity sensor bays 338 and its corresponding first and second support walls 340, 342, pegs 344, and struts 346 are labeled with reference numbers. The external portions of the game piece 300 shown in FIGS. 11A-11B can be the same as the external portions of the game piece 100 shown in FIGS. 1-9B. Unlike the game piece 100, the game piece 300 can include no top magnet attached to the underside of the top wall 324. As shown in FIG. 11B, the game piece 300 can include a bottom magnet 326 and a proximity sensor 332 similar to the bottom magnet 126 and the proximity sensor 132 of the game piece 100, but at different circumferential positions.

The proximity sensor 332 of the game piece 300 also can have a different configuration than the proximity sensor 132 of the game piece 100. As discussed above, the proximity sensor 132 can be activated by a proximity sensor target positioned above the proximity sensor. In contrast, the proximity sensor 332 can be activated by a proximity sensor target positioned below the proximity sensor. In this alternative configuration, the spring (not shown) can be positioned in the lower spring compartment (not shown) and the contact plate 368 can wrap around the bottom of the lower spring compartment. Similar to the configuration shown in FIGS. 9A-9B, the spring in the alternative configuration can be separated from the contact plate 368 when at rest and move into contact with the contact plate when influenced by the magnetic field of a magnet of a separate game piece positioned in close proximity and below the proximity sensor 332.

The proximity sensors and proximity sensor targets shown and described are exemplary only. In other embodiments, game pieces can include different components to detect and trigger one another based on physical proximity. In game pieces that include magnets, for example, a variety of types of magnets can be used. The top magnets 122, 222, 322 and bottom magnets 126, 226, 326 of the game pieces 100, 200, 300 can be cylindrical, neodymium magnets. In other embodiments, a game piece can include, for example, another type of permanent magnet (e.g., ceramic or another type of rare earth magnet) having the same or a different shape (e.g., cuboid). In still other embodiment, a game piece can include temporary magnets. For example, in these embodiments, a game piece can include an electromagnet activated when a switch is triggered, such as by physical interaction with a separate game piece.

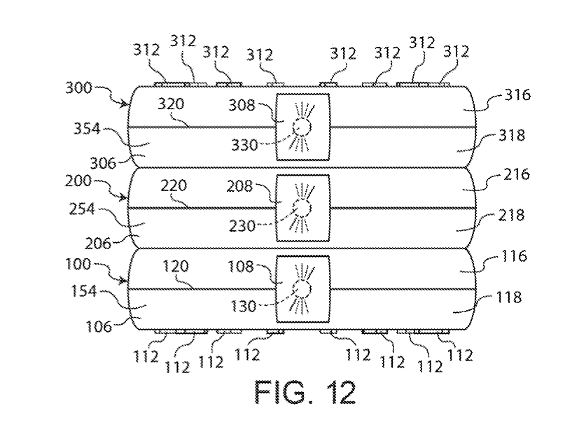

The circumferential positions of the top magnets 122, 222, 322, bottom magnets 126, 226, 326, and proximity sensors 132, 232, 332 of the game pieces 100, 200, 300 can determine how the game pieces interact with one another. As shown in FIG. 12, when stacked with the game piece 100 on the bottom, the game piece 200 in the middle, the game piece 300 on the top, and the lights 130, 230, 330 aligned, the lights can all be simultaneously illuminated. In this configuration, the bottom magnet 226 of the game piece 200 can activate the proximity sensor 132 of the game piece 100, the bottom magnet 326 of the game piece 300 can activate the proximity sensor 232 of the game piece 200, and the top magnet 222 of the game piece 200 can activate the proximity sensor 332 of the game piece 300. The interactivity of the game pieces 100, 200, 300 is exemplary only of the possible interactivity of game pieces of sets of game pieces in accordance with embodiments of the present technology. Depending, for example, on the number of game pieces in a set, the number of proximity sensor and proximity sensor target positions within each game piece, and the number of proximity sensors and proximity sensor targets within each game piece, dozens, hundreds, thousands, millions, or greater numbers of different sets can be created.

In some embodiments, the game piece can include no proximity sensors, one proximity sensor (e.g., similar to the game pieces 100, 200, 300), two, three, four, five, six, seven, eight, nine, ten, or another suitable number of proximity sensors. Similarly, the game piece can include no proximity sensor targets, one proximity sensor target (e.g., similar to the game piece 300), two proximity sensor targets (e.g., similar to the game pieces 100, 200), three, four, five, six, seven, eight, nine, ten, or another suitable number of proximity sensor targets. Multiple proximity sensors can be electrically connected in parallel (e.g., such that activation of any one of the proximity sensors activates the light of the game piece) or in series (e.g., such that activation of all of the proximity sensors is required to activate the light of the game piece).

As discussed above, sets of game pieces can be configured such that some or all of the game pieces in the set can be positioned in a winning arrangement. Different game pieces also can be distributed for amusement with no predetermined winning arrangement. A winning arrangement of game pieces can be one in which a certain number of game pieces (e.g., three, four, five, or another suitable number) are stacked with the lights aligned (or not aligned) and simultaneously illuminated. A game piece holder can be included to hold the stacks of game pieces such that the lights are visible. If the winning arrangement of game pieces is one in which a certain number of game pieces are stacked with the lights aligned and simultaneously illuminated, the game piece holder can include aligned windows or openings through which the lights of game pieces within the game piece holder are visible. If the winning arrangement of game pieces is one in which a certain number of game pieces are stacked with the lights not aligned and simultaneously illuminated, the game piece holder can include openings at different circumferential positions with each opening corresponding to the circumferential position of an illuminated light in a winning arrangement of game pieces. In some embodiments, holders with different patterns of openings can be provided in conjunction with sets of game pieces. When used in a sweepstakes, the different holders can be exchangeable for different prizes when completed.

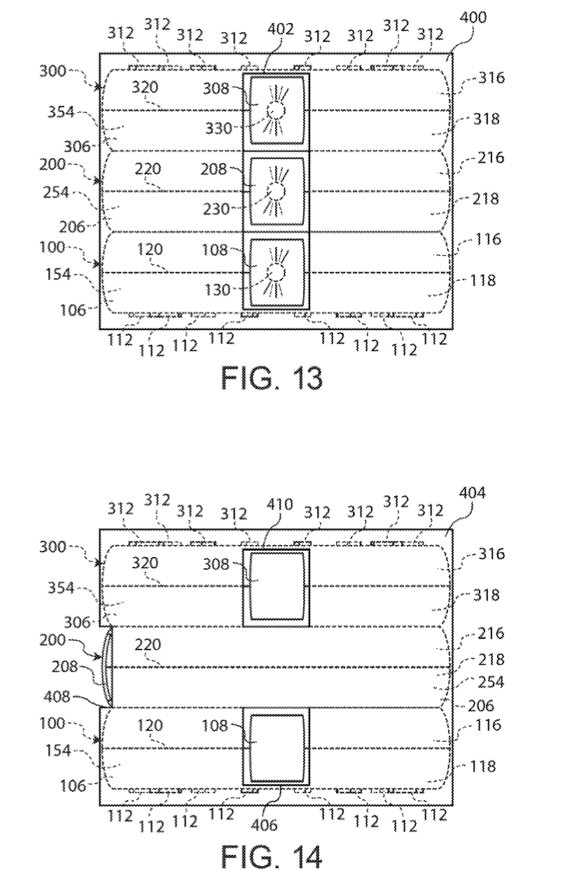

FIGS. 13 and 14 illustrate the game pieces 100, 200, 300 within two different types of game piece holders. In FIG. 13, the game pieces 100, 200, 300 are shown positioned within a first game piece holder 400 having a vertical opening 402 through which the windows 108, 208, 308 of the game pieces 100, 200, 300 are visible when the windows are aligned. The lights 130, 230, 330 are shown illuminated in FIG. 13 because, for example, the game pieces 100, 200, 300 can be configured such that the lights are illuminated when positioned as shown in FIG. 13. In FIG. 14, the game pieces 100, 200, 300 are shown positioned within a second game piece holder 404 having a first opening 406, a second opening 408, and a third opening 410 through which the windows 108, 208, 308 of the game pieces 100, 200, 300 are visible, respectively, when positioned as shown in FIG. 14. The lights 130, 230, 330 are shown not illuminated in FIG. 14 because, for example, the game pieces 100, 200, 300 can be configured such that the lights are not illuminated when positioned as shown in FIG. 14.

As discussed above, game pieces in accordance with embodiments of the present technology can be either physical or virtual. In some cases, the game pieces can also be convertible from physical to virtual and/or convertible from virtual to physical. For example, a physical game piece can include a code or other information that can be entered into a computing device (e.g., a mobile computing device) to generate a corresponding virtual game piece. This code, for example, can be a numeric or alphanumeric code configured to be entered into the computing device manually, a bar code configured to be entered into the computing device automatically (e.g., via a bar code reader), or have another suitable form. Similarly, a virtual game piece can be convertible into a physical form (e.g., by two-dimensional or three-dimensional printing). This can be useful, for example, when physically observing and/or manipulating the game piece is desirable, such as to allow a user to physically arrange the game piece with other game pieces for amusement or in an attempt to create a redeemable set. As discussed above, this type of observation and manipulation can also occur in a virtual environment.

Virtual game pieces can be distributed electronically and, in some cases, one or more network devices can track various aspects of the game pieces. As an example, one or more network devices can track (e.g., via game piece identifiers) game piece ownership, game piece types, game piece values (e.g., values of the game pieces relative to one another), and game piece status (e.g., expired, active, etc.), among other aspects. The network devices can also track redemption criteria and/or other information relevant to use of the game pieces. Each individual game piece can be associated with one or more advertisers (e.g., one, two, three, or a greater number of advertisers) operating independently or collaboratively. Separate game pieces can be associated with the same advertiser or different advertisers operating independently or collaboratively. As an example, a first game piece can be associated with a first advertiser or group of advertisers, a second game piece can be associated with a second advertiser or group of advertisers, a third game piece can be associated with a third advertiser or group of advertisers, and the first, second, and third advertisers or groups of advertisers can be different. In some embodiments, game pieces can indicate with which advertiser or group of advertisers they are associated (e.g., by placement of one or more logos or other marketing information on visible representations of the game pieces).

Distribution criteria can specify when game pieces are to be distributed. As an example, distribution criteria can specify that game pieces are to be distributed based on one or more specified consumer actions or attributes. Consumer actions that can be specified by the distribution criteria include, for example, purchasing a product (e.g., during a particular promotion), visiting a website (e.g., to research a product before purchasing the product), completing a marketing survey, moving from one geographical location (e.g., a retail location associated with a competitor of an advertiser) to another geographical location (e.g., a retail location associated with the advertiser), and moving from one website (e.g., a website associated with a competitor of an advertiser) to another website (e.g., a website associated with the advertiser), among others. In some cases, distribution criteria that specify purchasing activity can further specify an alternative consumer action for receiving game pieces that does not include making a purchase. As an example, the alternative consumer action can include requesting (e.g., by mail, email, text message, or web form) that physical game pieces be sent to the consumer by mail and the physical game pieces can be convertible into virtual game pieces equivalent to the game pieces that would have been distributed to the consumer in response to making the purchase.

Consumer attributes that can be specified by the distribution criteria can include, for example, personal characteristics (e.g., age and gender), geographical locations, and status within social media platforms (e.g., friend status with an advertiser or with an existing customer of the advertiser), among others. As an example, a first consumer and a second consumer can be linked (e.g., as friends) on a social media platform, and, when the first consumer satisfies distribution criteria (e.g., by making a purchase from an advertiser), the distribution criteria may specify that game pieces be distributed to both the first and second consumers. Input to determine whether distribution criteria specifying attributes are satisfied can be gathered (e.g., in real time) directly from consumers, from third parties with permission to share consumer information, or other suitable sources. As an example, input for distribution criteria based on geographical locations can be gathered from global-positioning-system locators or other suitable locators via applications that request permission to share location information for the purpose of receiving game pieces on mobile computing devices associated with consumers.

In some cases, the distribution criteria can serve a cross-promotional purpose. As an example, a manufacturer and a credit card company may collaborate to distribute game pieces such that a consumer who purchases items associated with the manufacturer using the credit card will receive one or more game pieces as a result of the purchase. As another example, three or more different advertisers can be involved in distribution criteria for a single distribution of one or more game pieces. The game pieces distributed in response to satisfaction of distribution criteria associated with multiple advertisers can be associated with one, some, or all of the advertisers. For example, satisfaction of distribution criteria associated with multiple advertisers can result in distribution of one or more game pieces associated with each of the advertisers individually or one or more game pieces associated with some or all of the advertisers collectively.

In some embodiments, a portion of the distribution criteria can specify the game pieces to be distributed in response to satisfaction of another portion of the distribution criteria. For example, a first portion of the distribution criteria can specify when game pieces are to be distributed, and a second portion of the distribution criteria can specify what game pieces are to be distributed and/or how the game pieces are to be distributed upon satisfaction of the first portion of the distribution criteria. In a particular example, the second portion of the distribution criteria may specify that a purchase from an advertiser within a first range (e.g., from $10 to $100) results in the distribution of a first number and/or type of game pieces to the purchaser, that a purchase from the advertiser within a second range (e.g., from $101 to $200) will result in the distribution of a second number and/or type of game pieces to the purchaser, and a than a purchase from the advertiser within a third range (e.g., from $201 to a maximum amount) will result in the distribution of a third number and/or type of game pieces to the purchaser, with the first, second, and third numbers and/or types having successively more value. Furthermore, the second portion of the distribution criteria can specify that the game pieces are to be distributed during an action (e.g., during a purchase), immediately after the action, or after a delay (e.g., a number of days) following completion of the action. In some cases, the distribution of game pieces after a delay can be used to encourage repetition of purchases or other desirable consumer activity.

With regard to how the game pieces are distributed, the distribution criteria can specify, for example, that a certain number and/or type of game pieces will be distributed consistently in response to satisfying the first portion of the distribution criteria or that the number and/or type of game pieces to be distributed will be partially or completely random (e.g., by chance). For example, when a particular game piece type is to be relatively rare, the second portion of the distribution criteria can specify that that the particular game piece type be distributed by chance at a relatively low probability upon satisfying the first portion of the distribution criteria. Similarly, when a particular game piece type is to be relatively common, the second portion of the distribution criteria can specify that that the particular game piece type be distributed by chance at a relatively high probability upon satisfying the first portion of the distribution criteria. In some cases, distribution criteria can specify actions that accompany the distribution of game pieces. For example, distribution criteria may specify that a notification of the distribution be sent to a consumer, that a notification of the distribution be sent to other consumers associated with the consumer (e.g., linked to the consumer within a social media platform), and/or that game piece ownership information be updated, among other actions.

Various games (e.g., events, contests, promotions, etc.) can be associated with redemption criteria with or without accompanying distribution criteria. For example, according to a particular game, a consumer who collects game pieces meeting redemption criteria for the game can receive a prize or other item of value by presenting collected game pieces satisfying the redemption criteria. In some embodiments, the redemption criteria can specify which game pieces are redeemable, such as which game pieces complete a redeemable set. In one example, a redeemable set includes a first game piece and a second game piece different than the first game piece. The first and second game pieces, for example, can have different unique identities and/or be of different types. In another example, a redeemable set includes more than one game piece (e.g., two, three, four, or another specific number of game pieces) of a first type and more than one game piece (e.g., two, three, four, or another specific number of game pieces) of a second type different than the first type. The redeemable set can also be more complex. For example, the set can include the same or different numbers of game pieces of three, four, five, six, or a greater number of different game piece types. By collecting specified game pieces and redeeming them, a consumer may be eligible to receive something of value (e.g., a prize). Thus, by specifying prizes and limiting access to the game pieces (e.g., via selection of distribution criteria), various values can be established for different game pieces.

As discussed above, in some cases, the distribution criteria can serve a cross-promotional purpose. Similarly, the redemption criteria alone or in conjunction with the distribution criteria can serve a cross-promotional purpose. For example, a redeemable set can include a first game piece distributed when an item is purchased from a first retailer and a second game piece distributed when an item is purchased from a second retailer. Thus, a consumer who possesses part of the redeemable set as a result of purchasing an item from only one of the first and second retailers may be motivated to purchase an item from the other of the first and second retailers so as to complete the set. The first and second retailers, for example, can have a nexus or a potential nexus among consumers. For example, game pieces associated with the first and second retailers can be selected for inclusion in the same redeemable set because marketing information indicates that consumers who find value in shopping at the first retailer also tend to find value in shopping at the second retailer. Thus, the redemption and distribution criteria can create value for both the consumer (e.g., by identifying a shopping opportunity that is likely to be compatible with the consumer's preferences) and the first and second retailers (e.g., by at least partially merging or otherwise expanding their customer bases).

Consumers can receive physical or virtual game pieces based on distribution criteria satisfied in physical or virtual space. As examples, a consumer may receive one or more physical game pieces when purchasing a product at a physical store (e.g., by a salesperson giving the physical game pieces to the consumer directly) or when purchasing a product at an online store (e.g., by mail with the purchased product or separate from the purchased product). Similarly, a consumer may receive one or more virtual game pieces when purchasing a product at a physical store (e.g., by a salesperson sending authorization for distribution of the virtual game pieces) or when purchasing a product at an online store (e.g., by an automated process similar to conventional processes used to automatically send electronic confirmations and receipts). Virtual game pieces can be distributed, for example, via electronic mail, text messaging, wireless communication between two computing devices (e.g. between a mobile computing device and server), or in another suitable manner.

In some embodiments, a clearinghouse, which can be, for example, a game piece distributor or another suitable entity, can perform clearinghouse functions related to game pieces. These functions, for example, can include clearing and/or settling game piece trading activity (e.g., aggregating and/or validating game piece related transactions), clearing and/or settling game piece distribution activity, and clearing and/or settling game piece redemption activity, among other suitable functions. In some embodiments, the entity acting as a clearinghouse or another suitable entity can manage game piece information (e.g., collecting and/or storing tracking, ownership, trading, redemption, and/or other types of game piece information), report game piece information (e.g., provide analytical reports to advertisers), and/or provide other suitable functions involving game piece information. Furthermore, the entity acting as a clearinghouse or another suitable entity can manage creation of game pieces. Advertisers can, in some cases, pay a fee to the clearinghouse or other suitable entity to perform clearinghouse functions, to provide game piece information, to analyze game piece information, and/or to manage creation of game pieces.

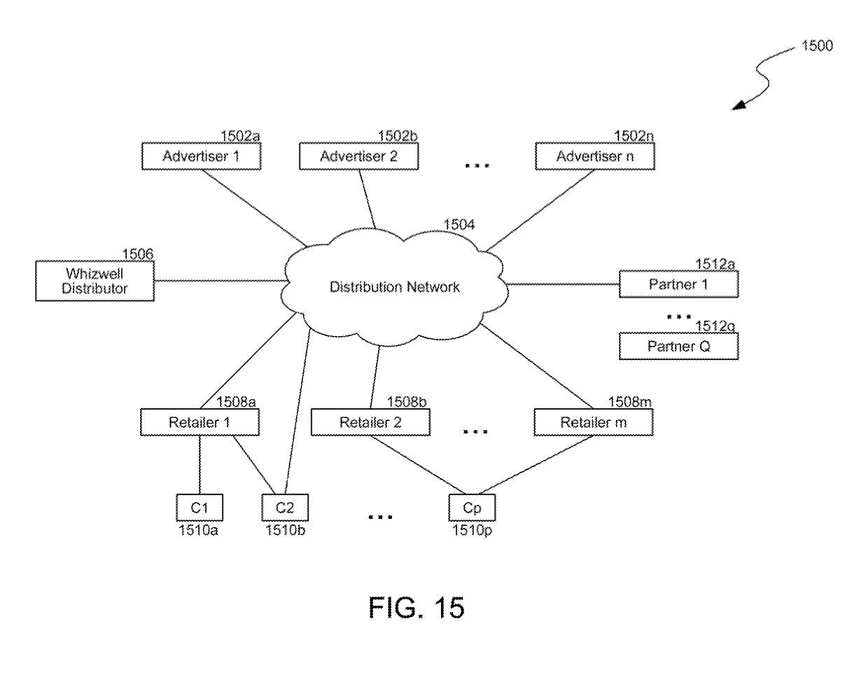

Referring to FIG. 15, in some embodiments, the present technology can operate in an environment 1500 including one or more advertisers (e.g., advertiser 1502a, advertiser 1502b, and so forth). The advertisers can communicate (e.g., via a network 1504) with a game piece distributor 1506. As an example, the advertisers can request game pieces, indicate and/or request values for game pieces, indicate and/or request identification of actual or potential collaborating advertisers, indicate and/or request distribution criteria, indicate and/or request redemption criteria, and so forth. The network 1504 can be a data communications network (e.g., the Internet, an intranet, or another suitable network). In some embodiments, the game piece distributor 1506 creates game pieces and stores information about the created game pieces (e.g., to whom the game pieces are distributed, transaction information, distribution criteria, redemption criteria, redemption prizes, etc.). In other embodiments, another suitable entity (e.g., in collaboration with the game piece distributor) can create the game pieces and/or store the information. One or more retailers (e.g., retailer 1508a, retailer 1508b, and so forth) can also connect via the network 1504. As an example, the game piece distributor 1506 may distribute game pieces to the retailers and receive transaction and redemption information from the retailers. Consumers may also trade game pieces or participate in an exchange of game pieces. Thus, game pieces can be distributed to consumers using various distribution mechanisms.

In some cases, consumers can receive game pieces from and/or redeem game pieces with the game piece distributor 1506 via the retailers, the advertisers, or other suitable entities (e.g., a partner 1512a). In other cases, consumers can receive game pieces from and/or redeem game pieces with the game piece distributor 1506, retailers, the advertisers, or other suitable entities directly. Furthermore, the consumers can connect to the network 1504 via the retailers, the advertisers, or other suitable entities and/or directly. As an example, a consumer 1510a may connect via the retailer 1508a; a consumer 1510b may connect via both the retailer 1508a and directly; and a consumer 1510p may connect via the retailer 1508b and a retailer 1508m. The consumers may connect to the network 1504, for example, to receive game pieces, to redeem game pieces, to change game piece ownership information (e.g. to trade game pieces with others), and/or to engage in other suitable activities related to game pieces. The partner 1512a can be an entity, for example, that participates in the game piece environment by providing prizes when a consumer redeems a set of game pieces with the partner 1512a. As an example, a game associated with an advertiser may specify that when a consumer redeems a particular set of game pieces, the consumer will be provided with a free stay at a hotel chain partner of the advertiser. The advertiser may, in turn, receive a volume discount with from the hotel chain partner.

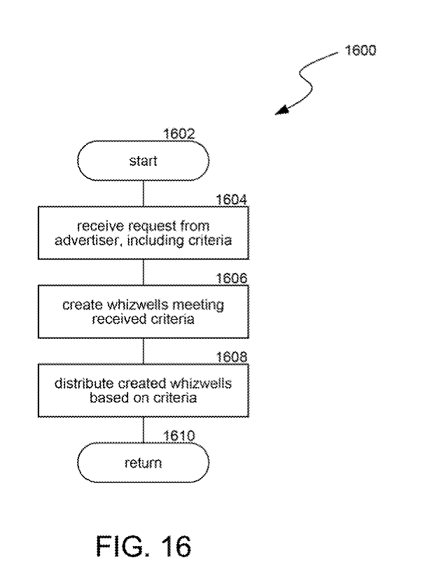

FIG. 16 is a flow diagram illustrating a routine invoked by the present technology in some embodiments to create and distribute game pieces. The routine 1600 begins at block 1602. At block 1604, the routine receives a request from an advertiser. In some embodiments, the request can include various criteria. As examples, the request can include criteria for creating game pieces, redeeming game pieces, and/or distributing game pieces. In other embodiments, the request can be a request for the routine 1600 to supply such criteria. At block 1606, the routine can cause the creation of game pieces meeting the criteria. As examples, the routine may add entries to a database of virtual game pieces or may place an order for the creation of physical game pieces. At block 1608, the routine can distribute the created game pieces (e.g., based on criteria from the advertiser).

New games (e.g., new redemption criteria with or without accompanying distribution criteria) and/or new game pieces can originate from a game piece distributor, an advertiser, a consumer, or another suitable entity. Furthermore, in some cases, new games can originate from the collaboration of multiple entities. For example, an advertiser may specify redemption criteria and a first portion of distribution criteria for a new game and a game piece distributor may specify a second portion of the distribution criteria for the game. Redemption criteria from an advertiser, for example, can specify that only game pieces associated with the advertiser are redeemable for prizes provided by the advertiser, that game pieces associated with the advertiser in combination with game pieces associated with other advertisers are redeemable for prizes provided by the advertiser, or that game pieces associated with any advertiser are redeemable for prizes provided by the advertiser. In the latter case, for example, the advertiser may seek market exposure via game piece redemption activity rather than game piece distribution activity.

In some cases, a consumer (e.g., via an email suggestion) or a group of consumers (e.g., via a petition or survey) may suggest all or a portion of a new game. As an example, a consumer (e.g., based on the consumer's own behavior or the consumer's observed behavior of others) may recognize a synergy between two different advertisers and propose a game that rewards purchasing or other suitable activity with both of the advertisers. Consumer input also can be used, for example, to designate new prizes or new types of game pieces. Adopted suggestions from consumers regarding new games and/or portions of games can be incentivized by advertisers (e.g., via rewards) and/or serve as an incentive to consumers (e.g., the opportunity to create a new game and/or to designate a new prize can serve as a reward). In a particular example, a consumer may be given the opportunity to create a new game, to create a new game piece type, or to distribute game pieces (e.g., to the consumer's friends) as a reward for active participation in a game piece network.

In some embodiments, a game piece distributor may approach an advertiser or group of advertisers with marketing opportunities. As an example, a game piece distributor may observe trends in the market (e.g., trends related to distribution and/or redemption activity of game pieces associated with various advertisers or groups of advertisers) and identify marketing opportunities based on the trends. These marketing opportunities, for example, can be potential cross-promotional games, potential participation in networks of advertisers currently participating or planning to participate in one or more games, potential games specific to the contacted advertiser or group of advertisers (e.g., games designed to encourage consumers to increase purchasing activity with the advertiser or group of advertisers), and/or other suitable opportunities.

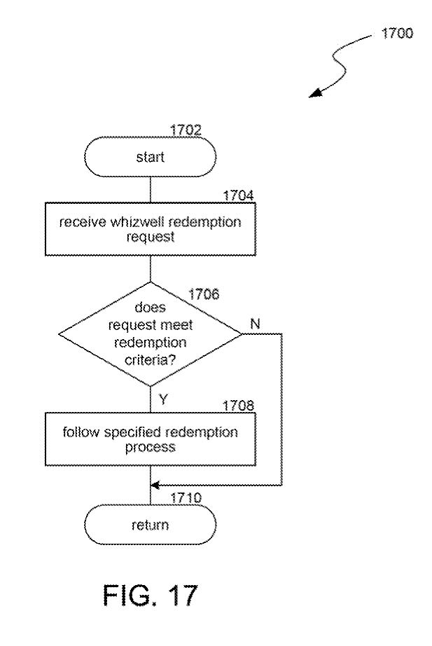

FIG. 17 is a flow diagram illustrating a routine invoked by the present technology in some embodiments when a consumer redeems game pieces. The routine 1700 begins at block 1702. At block 1704, the routine receives a request to redeem one or more game pieces. As an example, a consumer can request redemption of a first game piece of a first type and a second game piece of a second type (alone or in combination with other game pieces) in exchange for a specified or unspecified prize. At decision block 1706, the routine can determine whether the received request meets redemption criteria for a game (e.g., a game specified in the request or a game determined by the routine to correspond to game pieces identified by the redemption request). If the redemption criteria are satisfied (e.g., if the game pieces identified by the redemption request complete a set), the routine can continue at block 1708. Otherwise, the routine can return to block 1710.

At block 1708, the routine can follow a redemption process. As an example, the routine can receive from a consumer an indication of a desired prize, order the desired prize, and cause the ordered prize to be shipped to the consumer. As another example, the routine can automatically generate the prize (e.g., by randomly selecting among multiple prizes according to a specified probability). The routine then returns to block 1710. Redeemed game pieces, for example, can be destroyed (e.g., have their identity erased or be physically destroyed), be held by the game piece distributor or other redeeming entity for eventual redistribution or other use, be recycled into new game pieces, or be processed in another suitable manner. In some cases, redemption criteria can specify actions that accompany the redemption of game pieces. For example, redemption criteria may specify that a notification of the redemption be sent to a consumer and/or that a notification of the redemption be sent to other consumers associated with the consumer (e.g., linked to the consumer within a social media platform). Furthermore, the redemption criteria may specify that one or more redemption accruals (e.g., total dollars or numbers of game pieces redeemed) be updated. Redemption accruals, for example, can be maintained for consumers, games, advertisers, an entire network, and/or other suitable bases for a particular time window (e.g., daily, weekly, monthly, annually, since inception, etc.).

In some embodiments, the redemption process can include automatically or manually manipulating visual representations of game pieces within a virtual environment. For example, software on a computing device accessible to a consumer can be configured to generate virtual environments in which visual representations of game pieces can be automatically or manually manipulated. A virtual environment can be compatible with a single game or multiple games. Similar, a virtual environment can be compatible with a single advertiser or multiple advertisers. As an example, multiple virtual environments can be individually associated with a single advertiser and a single game, multiple advertisers and a single game, or multiple games and a single advertiser. In the latter case, for example, an advertiser may be associated with a single virtual environment compatible with all games associated with the advertiser. A virtual environment associated with an advertiser or a group of advertisers can include one or more logos for the advertiser or group of advertisers.

Manual manipulation of game pieces within a virtual environment, for example, can include sliding visual representations of the game pieces (e.g., using a touch screen) to achieve different arrangements of the game pieces. In some cases, redeeming the game pieces can require the exercise of some skill. For example, redeeming the game pieces can include manually manipulating visual representations of the game pieces as puzzle pieces. In other cases, redeeming the game pieces can require no skill. Furthermore, redeeming the game pieces within the virtual environment can involve an element of chance. For example, pressing a button within the virtual environment can cause the game pieces to be automatically manipulated into a random arrangement that may or may not be a redeemable arrangement. The game pieces also may be used in various suitable contests (e.g., tick-tack-toe) against a virtual competitor. The virtual environments can have various features associated with the compatible game or games. For example, a virtual environment can include a virtual game piece holder similar to the game can include a virtual game piece holder (e.g., a virtual game piece holder similar to the first game piece holder 400 described above with reference to FIG. 13 and/or the second game piece holder 404 described above with reference to FIG. 14).

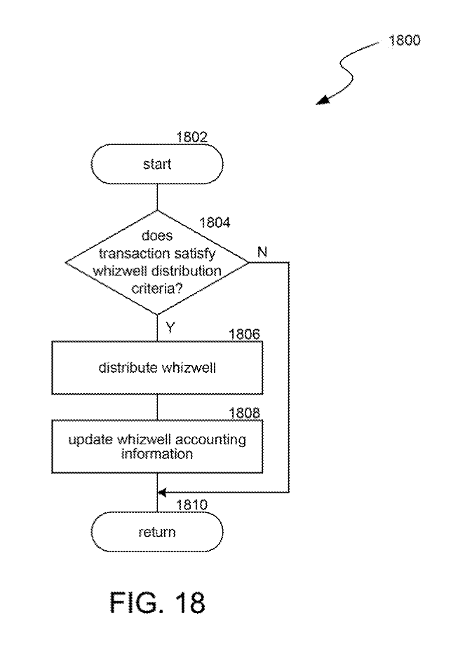

FIG. 18 is a flow diagram illustrating a routine invoked by the present technology in some embodiments to distribute game pieces. The routine 1800 begins at block 1802. At decision block 1804, the routine determines whether a transaction (e.g., a sales transaction) satisfies distribution criteria for game pieces. If the criteria are satisfied, the routine continues at block 1806. Otherwise, the routine continues at block 1810. At block 1806, the routine distributes game pieces. At block 1808, the routine updates accounting information for the game pieces. As an example, the routine may identify that a particular number of game pieces have been distributed, to whom the game pieces have been distributed, etc. The routine then returns to block 1810. As discussed above, in some cases, game piece distribution criteria may be unrelated to sales transactions. As examples, game pieces may be distributed during an advertising campaign (e.g., based on a consumer's profile). Alternatively, game pieces may be distributed based on where the consumer happens to be at a particular time (e.g., as derived from a consumer's geographical coordinates), etc.

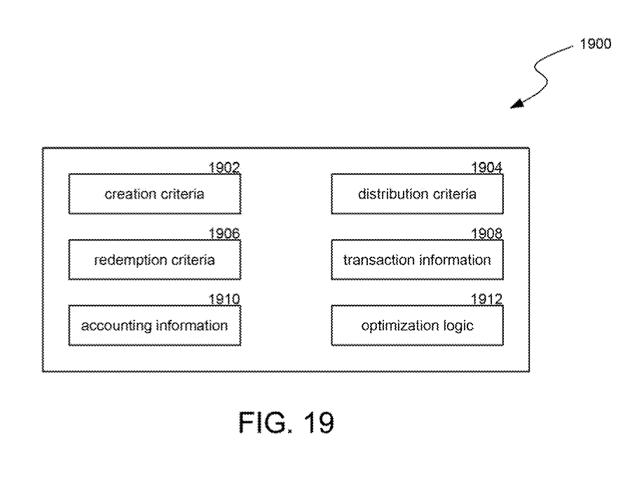

FIG. 19 is a block diagram illustrating components 1900 employed by the present technology in at least some embodiments. The components 1900 can include creation criteria 1902, distribution criteria 1904, redemption criteria 1906, transaction information 1908, accounting information 1910, and optimization logic 1912. The optimization logic 1912 can be used, for example, to provide a consumer with assistance in collecting and/or redeeming game pieces. In some embodiments, the optimization logic 1912 suggests opportunities for collecting game pieces of general value. As an example, when a consumer is purchasing an item, the optimization logic 1912 can recommend using a particular credit card or shopping at an alternate retailer to increase (e.g., maximize) the value of collected game pieces. Furthermore, in these and other embodiments, the optimization logic 1912 can suggest opportunities for collecting game pieces of special value to the consumer (e.g., game pieces that can be combined with game pieces within the consumer's inventory of game pieces to form a redeemable set and/or game pieces useable in games in which the consumer is participating). The input to the optimization logic 1912 can include, for example, the consumer's existing inventory of game pieces, the consumer's specified or predicted preferences, and a list of games in which the consumer is participating, among other information.

The opportunities, for example, can be actions that a consumer can take or potential trades that a consumer can make. As an example, the optimization logic 1912 can identify one or more first game pieces of special value to a first consumer and determine whether other consumers (e.g., other consumers linked to the first consumer within a social media platform) are in possession of the identified first game piece(s). If so, the optimization logic 1912 can identify one or more second game pieces within the first consumer's inventory of game pieces that would be of greater value to a second consumer who is in possession of the identified first game piece(s). The first and second consumers can then be prompted for permission to trade the first game piece(s) for the second game piece(s).

The optimization logic 1912 can also be used to suggest redemption opportunities and/or new games. As an example, the optimization logic 1912 may provide a consumer with a list of prizes that are available or nearly available based on the consumer's inventory of game pieces. The list can be based, for example, on redemption opportunities associated with games in which the consumer is participating or a broader set of games (e.g., all active games within a network). As another example, the optimization logic 1912 may determine that some game pieces within a consumer's inventory of game pieces are about to expire and then suggest one or more prizes for which the expiring game pieces could be redeemed. As yet another example, the optimization logic 1912 may determine that a prize in which the consumer is likely to be interested (and for which the consumer has appropriate game pieces to satisfy the redemption criteria associated with the prize) is about to become unavailable and may suggest redemption before this occurs. In some cases, a learning algorithm can be used to learn a consumer's preferences over time (e.g., by observing the consumer's use of game pieces). The algorithm can then use the learned preferences to change the suggested redemption opportunities and/or new games. Suggesting redemption opportunities and/or new games, for example, can include alerting the consumer (e.g., via email, text messaging, push notification, a Web site, or another suitable type of communication).

The optimization logic 1912 can be controlled by a game piece distributor, by an advertiser, by a consumer, or by another suitable entity. For example, when a game piece distributor controls the optimization logic 1912, the game piece distributor can use ownership information also controlled by the game piece distributor to identify an inventory of game pieces belonging to a particular consumer, and then use that inventory as input for the optimization logic 1912. Alternatively or in addition, the game piece distributor can request access to a game piece inventory stored by a consumer (e.g., in memory within a computing device associated with the consumer). When a consumer controls the optimization logic 1912, the optimization logic may be within software that the consumer accesses, such as software licensed to the consumer. Accordingly, the optimization logic 1912 itself may have value (e.g., as a source of licensing and/or advertising revenue). Furthermore, different types of optimization logic 1912 may be available to consumers, such as different software programs of varying levels of sophistication and cost.

Active games may change over time (e.g., existing games may expire and new games may be added). The redemption criteria associated with new games can specify only yet-to-be created game pieces, only existing game pieces, or a combination thereof. In some cases, a consumer who is unable to collect game pieces to satisfy redemption criteria for one game (e.g., because the game has expired) may nevertheless be able to use the collected game pieces for a different game. A game piece distributor or another suitable entity can provide (e.g., for a fee) access to a current list of active games. As active games change, the value of associated game pieces may change. Furthermore, in some cases, game pieces may expire. For example, a game piece distributor or an advertiser may identify an expiry date for game pieces and entities dealing in the game pieces may honor the expiry date (e.g., because a clearinghouse no longer honors transactions using the game pieces after the expiry date).

In some embodiments, a consumer can accept or refuse offered game pieces based on filtering criteria. Similarly, a game piece distributor or other suitable entity can determine whether or not to offer game pieces based on the same or different filtering criteria. For example, game pieces may be offered to the consumer on a regular basis and the consumer can use filtering criteria to automatically accept or reject the offered game pieces with or without an accompanying notification to the consumer. The filtering can occur at a computing device (e.g., a mobile computing device) associated with the consumer, a computing device associated with the game piece distributor or other suitable entity, or at another suitable location. In some cases, a learning algorithm can be used to learn the consumer's preferences over time (e.g., by observing the consumer's acceptance of offered game pieces, rejection of offered game pieces, and/or use of game pieces) and then to use the learned preferences to change the filtering criteria. The filtering criteria also can be set, for example, based on a consumer's specified or predicted preferences. In one example, a consumer can specify a list of games in which the consumer wishes to participate and the filtering criteria can reject offered game pieces not compatible with any of the selected games. In another example, a consumer can specify that only game pieces of a particular value or from a particular source are to be accepted. The filtering criteria can also be based on the expiry dates of offered game pieces, the prizes for which the offered game pieces are redeemable (e.g., in combination with other offered game pieces), and/or other suitable criteria.

Game piece information (e.g., accounting information, ownership information, distribution information, redemption information (e.g., redemption accruals), and other information associated with game pieces) can have value beyond game piece management. For example, when game pieces are used as part of a marketing campaign, information related to distribution and redemption of the game pieces can be analyzed to determine the productivity of the campaign or for other for marketing purposes. In some cases, analyzing game piece information can include analyzing the number of times a particular game piece changes ownership. These changes in ownership can be characterized as impressions (e.g., similar to impressions in the context of media advertising). As an example, a game piece may be distributed to a first consumer who then distributes it to a second consumer. Thus the game piece can be said to have caused two impressions. In some cases, game piece impressions can be tracked (e.g., by the game piece distributor) and fees charged to advertisers associated with the game pieces based on the impressions.

Certain game piece information and/or changes to game piece information may trigger notifications. For example, a game piece distributor or another suitable entity may receive a list of games in which a consumer is participating and automatically notify other consumers associated with the consumer (e.g., linked to the consumer within a social media platform) of the list and/or changes to the list. In some cases, this notification can accompany distribution criteria. For example, a notification of an opportunity to collect game pieces useable within a particular game can be sent to a consumer when the consumer takes a particular action or has a particular attribute in addition to being associated with another consumer who is participating in the game. In other cases, association with a consumer participating in a particular game alone can be sufficient to trigger a distribution of one or more game pieces.

A marketing campaign may be deemed successful, for example, based on different levels of distribution (e.g., number and/or value of game pieces distributed for the advertiser) and/or redemption (e.g., number and/or value of game pieces redeemed for one or more games). Some game pieces may be accepted (e.g., not rejected using filtering criteria) by more consumers than other game pieces. This can be the case, for example, for game pieces perceived by consumers to have greater values than other game pieces. In some cases, an advertiser may desire to distribute a much larger number of game pieces than are redeemed, and a marketing campaign may be deemed successful when a relatively small percentage of distributed game pieces are redeemed. Alternatively, an advertiser may desire that a relatively large number of distributed game pieces be redeemed. Because an entity (e.g., the game piece distributor or other entity acting as a clearinghouse) can collect data on how many game pieces are distributed, traded, and/or redeemed, the entity may be able to help advertisers and others determine whether or not particular advertising campaigns are successful. In some embodiments, a game piece distributor or another suitable entity may determine whether an advertising campaign is successful, at least in part, by determining a ratio of a number of distributed game pieces relative to a number of redeemed game pieces, by determining the number of consumers who wanted or needed a particular game piece (e.g., to complete a redeemable set), but were not able to acquire it (e.g., due to low probability of distribution), by determining the number of consumers participating in a particular game, and/or by determining another suitable factor. These and other factors can be determined, monitored, and/or reported both after a game has expired and during the course of a game (e.g., in real time).

In some embodiments, certain game piece information is publicly displayed (e.g., via a website, a free application, or another suitable platform) to indicate the relative activity and/or popularity of games, advertisers, and/or other suitable portions of a game piece network. This information, for example, can be used to encourage consumers to try new games (e.g., popular games) and/or can attract interest and/or increased participation in the overall game piece network among consumers and advertisers. In these and other embodiments, more advanced game piece information (e.g., the information described above in the context of determining whether a marketing campaign is successful) can be made accessible through a subscription service (e.g., a fee-based subscription service) to advertisers.

Optimization logic can be used in some cases to enhance ongoing marketing campaigns. As an example, optimization logic can compute an advertiser's exposure to game piece redemption during the course of a campaign. A particular advertiser may have allocated a budget for a campaign. If collected game piece information indicates a relatively low rate of redemption for game pieces associated with the campaign (e.g., that game pieces associated with the campaign are distributed in large numbers, but rarely redeemed), the advertiser's exposure to redemption may be determined to be relatively low. This information can be used to enhance (e.g., to optimize) the number of game pieces distributed as part of the campaign so that the final cost of the campaign corresponds relatively closely to the budget. This information can also be used to modify the budget for the campaign and/or to change other aspects of the campaign (e.g., the redemption criteria, the distribution criteria, the prizes, etc.) so as to enhance the performance of the campaign.

In at least some embodiments, computing devices on which aspects of the present technology can be implemented include a screen (e.g., a touch screen), a processor (e.g., a central processing unit or other suitable processing circuitry), memory, an input device (e.g., a keyboard, a virtual keyboard, a touch screen, or a pointing device), an output device (e.g., a display device), and/or a storage device (e.g., a disk drive), among other components. The memory and storage devices, for example, can include computer-readable storage media encoded with non-transitory computer-executable instructions that store and/or implement one or more aspects of the present technology. In addition, instructions, data structures, and message structures in at least some embodiments can be transmitted via a computer-readable transmission medium, such as a signal on a communications link. Thus, “computer-readable media” includes both computer-readable storage media for storing information and computer-readable transmission media for transmitting information. Additionally, data used in some methods in accordance with the present technology may be encrypted. Various communications links may be used, such as the Internet, a local area network, a wide area network, a point-to-point dial-up connection, a cellular phone network, a wireless network, and so on.

The present technology may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in some embodiments, including cloud-based implementations.

Many embodiments of the present technology described herein may take the form of computer-executable instructions, including routines executed by a programmable computer. Those skilled in the relevant art will appreciate that aspects of the present technology can be practiced on computer systems other than those shown and described herein. Embodiments of the present technology may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on. Moreover, the present technology can be embodied in a special-purpose computer or data processor that is specifically programmed with non-transitory instructions, configured, or constructed to perform one or more of the computer-executable instructions described herein. Accordingly, the terms “computer” or “system” as generally used herein refer to any suitable data processor and can include Internet appliances and hand-held devices (including palm-top computers, wearable computers, cellular or mobile phones, multi-processor systems, processor-based or programmable consumer electronics, network computers, mini computers and the like).

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout to mean including at least the recited feature(s) such that any greater number of the same feature and/or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

I/We claim:

1. A method performed by a computing device having a processor and memory, comprising:
distributing first game pieces of a first type based on first distribution criteria specifying a first consumer action or attribute;
distributing second game pieces of a second type based on second distribution criteria specifying a second consumer action or attribute;
redeeming a set including one or more of the first game pieces and one or more of the second game pieces,
wherein—
the first type and the second type are different, and
the first consumer action or attribute and the second consumer action or attribute are different.

2. The method of claim 1, further comprising tracking ownership information for the distributed first and second game pieces.

3. The method of claim 1, further comprising:
creating the first game pieces; and
creating the second game pieces.

4. The method of claim 1, wherein:
(a) distributing the first game pieces includes distributing the first game pieces at a specified probability less than 100% in response to satisfaction of the first distribution criteria; or
(b) distributing the second game pieces includes distributing the second game pieces at a specified probability less than 100% in response to satisfaction of the second distribution criteria; or
(c) both (a) and (b).

5. The method of claim 1, wherein:
(a) the first consumer action or attribute is a purchase; or
(b) the second consumer action or attribute is a purchase; or
(c) both (a) and (b).

6. The method of claim 1, wherein:
(a) the first consumer action or attribute is a geographical location of a mobile computing device associated with the consumer; or
(b) the second consumer action or attribute is a geographical location of a mobile computing device associated with the consumer; or
(c) both (a) and (b).

7. The method of claim 1, wherein:
the first game pieces are associated with a first advertiser or group of advertisers;
the second game pieces are associated with a second advertiser or group of advertisers different than the first advertiser or group of advertisers; and
the predetermined set is a predetermined set of a cross-promotional game associated with the first or group of advertisers and the second advertiser or group of advertisers.

8. The method of claim 1, wherein:
the first game pieces are associated with a first advertiser or group of advertisers;
the second game pieces are associated with a second advertiser or group of advertisers different than the first advertiser or group of advertisers; and
the method further comprises—
receiving the first distribution criteria from the first advertiser or group of advertisers; and
receiving the second distribution criteria from the second advertiser or group of advertisers.

9. The method of claim 1, wherein the first and second game pieces are physical.

10. The method of claim 1, wherein the first and second game pieces are virtual.

11. The method of claim 1, further comprising creating a virtual game piece in response to an uploaded game piece identifier associated with a physical game piece.

12. The method of claim 1, further comprising:
(a) determining a ratio of a number of the first game pieces distributed to a number of the first game pieces redeemed; or
(b) determining a ratio of a number of the second game pieces distributed to a number of the second game pieces redeemed; or
(c) both (a) and (b).

13. The method of claim 1, wherein redeeming the set includes:
receiving a redemption request identifying game pieces to be redeemed;
determining whether the game pieces identified by the received redemption request satisfy redemption criteria specifying members of the set; and
redeeming the game pieces identified by the received redemption request if the game pieces identified by the received redemption request satisfy the redemption criteria.

14. The method of claim 13, wherein determining whether the game pieces identified by the received redemption request satisfy the redemption criteria includes determining whether the game pieces identified by the received redemption request complete the set.

15. The method of claim 13, wherein redeeming the game pieces includes providing a prize if the game pieces identified by the received redemption request satisfy the redemption criteria.

16. A method performed by a computing device having a processor and memory, comprising:
receiving a plurality of virtual game pieces;
storing the virtual game pieces in an inventory;
receiving redemption criteria specifying a redeemable set of virtual game pieces;
identifying the redeemable set within the inventory; and
generating a recommendation to redeem the redeemable set.

17. The method of claim 16, wherein receiving the virtual game pieces includes receiving one or more of the virtual game pieces via email, text messaging, wireless communication, or a combination thereof.

18. The method of claim 16, wherein receiving the virtual game pieces includes receiving one or more of the virtual game pieces based on a GPS location of the computing device.

19. The method of claim 16, further comprising receiving a user profile, wherein receiving the virtual game pieces includes receiving one or more of the virtual game pieces based on the user profile.

20. The method of claim 16, wherein the redeemable set includes one or more first virtual game pieces and one or more second virtual game pieces, the second virtual game pieces being different than the first virtual game pieces.

21. The method of claim 20, wherein:
the first virtual game pieces are associated with a first advertiser;
the second virtual game pieces are associated with a second advertiser different than the first advertiser; and
the redeemable set corresponds to a cross-promotional game associated with the first and second advertisers.

22. A method performed by a computing device having a processor and memory, comprising:
receiving a plurality of virtual game pieces;
storing the virtual game pieces in an inventory;
receiving redemption criteria specifying a redeemable set of virtual game pieces;
identifying a first portion of the redeemable set within the inventory;
identifying an opportunity to collect a second portion of the redeemable set; and
generating an alert indicating the opportunity.

23. The method of claim 22, wherein receiving the virtual game pieces includes receiving one or more of the virtual game pieces via email, text messaging, wireless communication, or a combination thereof.

24. The method of claim 22, wherein receiving the virtual game pieces includes receiving one or more of the virtual game pieces based on a GPS location of the computing device.

25. The method of claim 22, wherein identifying the opportunity includes identifying the opportunity based on a GPS location of the computing device.

26. The method of claim 22, wherein the redeemable set includes one or more first virtual game pieces and one or more second virtual game pieces, the second virtual game pieces being different than the first virtual game pieces.

27. The method of claim 26, wherein:
the first virtual game pieces are associated with a first advertiser;
the second virtual game pieces are associated with a second advertiser different than the first advertiser; and
the redeemable set corresponds to a cross-promotional game associated with the first and second advertisers.

28. A method performed by a computing device having a processor and memory, comprising:
receiving a plurality of virtual game pieces;
storing the virtual game pieces in an inventory;
receiving redemption criteria specifying a redeemable set of virtual game pieces, the redeemable set including one or more first virtual game pieces and one or more second virtual game pieces, the second virtual game pieces being different than the first virtual game pieces; and
filtering offered virtual game pieces.

29. The method of claim 28, wherein filtering offered virtual game pieces includes accepting one or more offered virtual game pieces belonging to the redeemable set, and refusing one or more offered virtual game pieces not belonging to the redeemable set.

30. The method of claim 28, further comprising using a learning algorithm to generate filtering criteria based on redeemed virtual game pieces, wherein filtering the offered virtual game pieces includes filtering the offered virtual game pieces based on the filtering criteria.

31. The method of claim 28, wherein receiving the virtual game pieces includes receiving one or more of the virtual game pieces via email, text messaging, wireless communication, or a combination thereof.

32. The method of claim 28, wherein receiving the virtual game pieces includes receiving one or more of the virtual game pieces based on a GPS location of the computing device.

33. The method of claim 28, wherein:
the first virtual game pieces are associated with a first advertiser;
the second virtual game pieces are associated with a second advertiser different than the first advertiser; and
the redeemable set corresponds to a cross-promotional game associated with the first and second advertisers.
